(19) United States
(12) Patent Application Publication
(10) Pub. No.: US 2021/0268419 A1
(43) Pub. Date: Sep. 2, 2021

(54) MODULAR FILTER ELEMENT

(71) Applicant: MADISON FILTER 981 LIMITED, Staffordshire (GB)

(72) Inventors: Detlef Hega, Bad Gandersheim (DE); Ian Chisem, Warrington Cheshire (GB); Purv Purohit, Berlin (DE)

(73) Assignee: MADISON FILTER 981 LIMITED, Stoke-on-Trent (GB)

(21) Appl. No.: 17/254,188

(22) PCT Filed: Jun. 18, 2019
(86) PCT No.: PCT/GB2019/051705

§ 371 Date: Dec. 18, 2020

(30) Foreign Application Priority Data
Jun. 19, 2018 (GB) 1810054.5

(51) Int. Cl. B01D 46/00; B01D 46/24

(52) U.S. Cl. CPC B01D 46/0005; B01D 46/2407; B01D 2265/022; B01D 2265/04; B01D 46/0021

(57) ABSTRACT

The present invention relates to a modular ceramic filter element comprising two or more elongate hollow bodies, wherein the elongate hollow bodies are formed to define twist-lock connection means for joining adjacent elongate hollow bodies together.

### TECHNICAL FIELD OF THE INVENTION

The present invention relates to a modular filter element, to a method of producing a modular filter element and to the use of the modular filter element in a filtration plant.

### BACKGROUND TO THE INVENTION

Hot gas filtration is a process by which particulate matter is filtered from gas streams that typically have a temperature between 200° C. and 900° C. Ceramic filter elements are often used instead of traditional textile filter elements to remove particulates from hot gas streams since they exhibit superior filtration characteristics and do not substantially degrade at higher temperatures. Most commercial single piece filter elements are available in lengths of up to 4.5 metres. However, it becomes increasingly difficult to manufacture, store, transport, handle and fit filter elements to a filter housing when the length of the filter element exceeds 3 metres, and in applications where thousands of filter elements may be needed, the filter plant footprint and its cost become prohibitive

Modular filter elements formed from multiple filter element sub-sections are known in the art and were developed to overcome or at least alleviate some of the above-mentioned problems. One known modular filter element utilises a screw connection to join adjacent filter element sub-sections together. However, such filter elements suffer from the disadvantage that they are expensive to manufacture due to the machining involved in forming the screw threads, e.g., it is particularly difficult to machine the screw threads without forming cracks during the machining operation. Moreover, due to the nature of the connection, such modular filter elements suffer from sealing issues which can lead to a reduction in filtration performance. Filter elements are also known to vibrate in use and therefore there is a risk of the filter element sub-sections becoming partly or fully unscrewed. It will be appreciated that if filter element sub-sections become partly unscrewed then filtration performance will decline due to the absence of a gas tight seal.

However, in more severe cases where the filter element sub-sections become fully unscrewed, the filter element sub-section below the joint may fall into a collection hopper thereby contaminating any filtered particulate matter in the hopper. Contamination of the particulate matter is undesirable, especially when the filtered particulate matter is valuable, and may result in the particulate matter having to be discarded and/or the filtering operation being halted while the filter element sub-section is removed from the hopper.

In light of the above it is an object of embodiments of the invention to provide a modular filter element that is more than 3 metres in length.

It is also an object of embodiments of the invention to provide a modular filter element that exhibits improved sealing performance at the interface between two filter element sub-sections.

It is a further object of embodiments of the invention to provide a modular filter element that enables a secure connection between two filter element sub-sections to be obtained.

### SUMMARY OF THE INVENTION

According to a first aspect of the invention there is provided a ceramic modular filter element comprising two or more elongate hollow bodies, wherein the elongate hollow bodies are formed to define twist-lock connection means for connecting adjacent elongate hollow bodies.

In some embodiments an adhesive may be provided at an interface between the elongate hollow bodies. The adhesive may be a high temperature adhesive. In particular, the adhesive may be a ceramic cement adhesive.

The respective ends of the elongate hollow bodies may be formed to define the twist-lock connection means. For example, the lower end of one elongate hollow body may be formed to define a male portion while the upper end of an adjacent elongate hollow body may be formed to define a female portion for receiving the male portion.

The male portion may comprise a radial pin and the female portion may comprise a slot for receiving the radial pin. In some embodiments the lower end of one elongate hollow body may comprise a plurality of radial pins. The radial pins may be diametrically opposed. Accordingly, the upper end of an adjacent elongate hollow body may comprise a plurality of slots or diametrically opposed slots for receiving the radial pins. The slots may be substantially L-shaped or substantially J-shaped.

The twist-lock connection means may be a bayonet connection. In such a connection, diametrically opposed slots formed in one elongate hollow body may be guided over diametrically opposed radial pins formed in an adjacent elongate hollow body, and then by twisting or turning one or both of the elongate hollow bodies, the slots engage with the pins to the lock the two elongate hollow bodies together.

In some embodiments the filter element may comprise a catalyst. The catalyst may be any catalyst that is capable of removing gaseous contaminants from a gas stream by selective catalytic reduction. In particular, the catalyst may enable acid gases, NOx and dioxins to be simultaneously removed from a gas stream.

The filter element preferably comprises non-threaded elongate hollow bodies.

Each elongate hollow body may be open at one end. In particular, an upper end of each elongate hollow body may be open.

The open end of one elongate hollow body may comprise a flange for securing the filter element to a filter housing of a filtration apparatus. Accordingly, the elongate hollow body comprising the flange will normally be the uppermost elongate hollow body of the filter element, in which case the lower end of this elongate hollow body may be configured to engage with an upper end of an adjacent elongate hollow body. The flange may be formed integrally with the elongate hollow body. The flange may be formed from a ceramic or ceramic based material.

The filter element may comprise one elongate hollow body having a closed end. The elongate hollow body may formed with a closed end or it may be formed with an open end and closed using an end cap. In use the elongate hollow body comprising the closed end will normally be the lowermost elongate hollow body in the filter element.

The length of the filter element may be greater than 3 metres. In particular, the filter element may have a length between 3 and 6 metres. In some embodiments the length of the first and second elongate hollow bodies is substantially the same. For example, the length of each elongate hollow body in a filter element formed from two hollow elongate hollow bodies, may be at least 1.5 metres, at least 2 metres, at least 2.5 metres or at least 3 metres.

Each elongate hollow body may have a substantially tubular profile. In some embodiments the filter element may be a filter candle.

According to a second embodiment of the invention there is provided a method of producing a modular filter element comprising two or more elongate hollow bodies, the method comprising the steps of:
providing a first elongate hollow body having a male portion formed at one end;
providing a second elongate hollow body having a female portion at one end;
guiding the female portion over the male portion, and
rotating one or both of the elongate hollow bodies to lock to male portion in the female portion.

According to a third aspect of the invention there is provided a filtration apparatus comprising the modular filter element according to first aspect of the invention. Accordingly, the filtration apparatus according to the third aspect of the invention may incorporate any or all of the features described in relation to the filter elements according to first aspect of the invention as desired or as appropriate.

According to a fourth aspect of the invention there is provided a use of the modular filter element according to the first aspect of the invention for filtering particulate matter from hot gas streams. Accordingly, the use of the filter element according to the fourth aspect of the invention may incorporate any or all of the features described in relation to the filter element according to first aspect of the invention as desired or as appropriate.

### DETAILED DESCRIPTION OF THE INVENTION

In order that the invention may be more clearly understood one or more embodiments thereof will now be described, by way of example only, with reference to the accompanying drawings, of which:

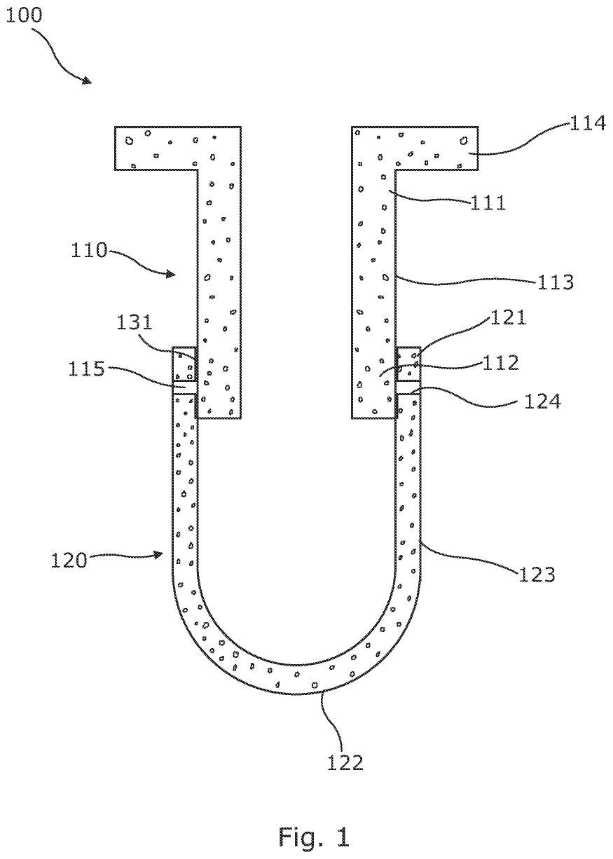

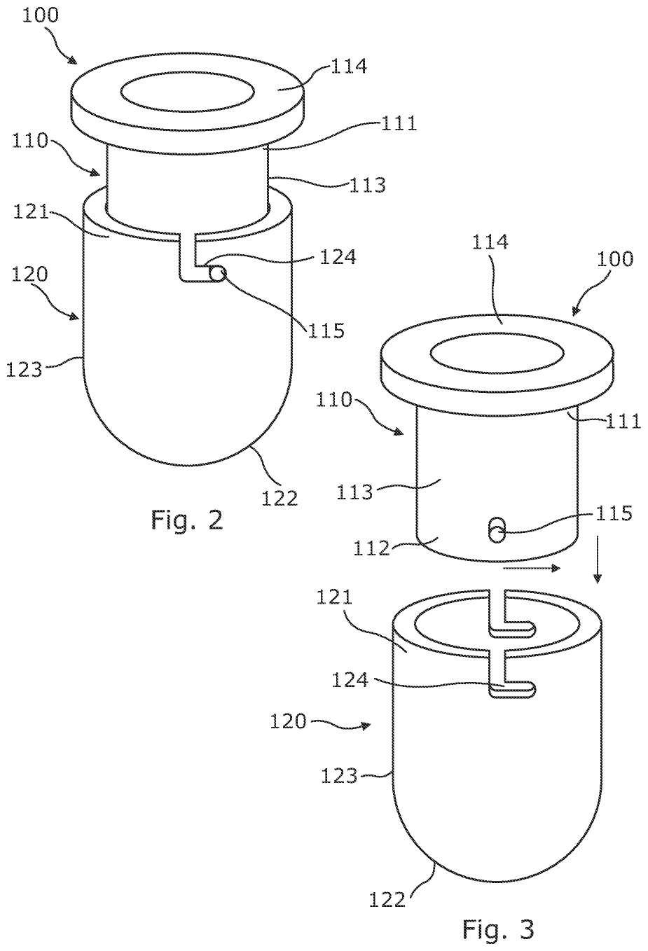

FIGS. 1 to 3 show a modular filter element in accordance with a first embodiment of the invention.

With reference to the drawings, and in accordance with an example of the present invention there is provided a ceramic filter element 100 for filtering particulate matter from hot gas streams. The modular filter element 100 comprises a first elongate hollow body 110 formed from a ceramic material having a length of about 3 metres and an external diameter of between 140 and 160 mm. The first elongate hollow body 110 has a substantially tubular profile that comprises an upper wall 111, a lower wall 112 and a side wall 113 that extends between the upper wall 111 and the lower wall 112. As best shown in FIG. 1, a flange 114 is located at an open upper end of the first elongate hollow body 110. The flange 114 is configured to enable mounting of the filter element 100 to a filter housing (not shown). As shown in FIG. 1 the lower end of the first elongate hollow body 110 is open and comprises two diametrically opposed radial pins 115.

The modular filter element 100 also comprises a second elongate hollow body 120. The second elongate hollow body 120 is about 3 metres in length and has an external diameter of between 140 and 160 mm. Accordingly, the length:width ratio of the modular filter element 100 is greater than that shown in the drawings. The second elongate hollow body 120 is formed from a ceramic material and has a substantially tubular profile. In particular, the second elongate hollow body 120 comprises an upper wall 121, a lower wall 122 and a side wall 123 that extends between the upper wall 121 and the lower wall 122. As best shown in FIG. 1 the lower wall 122 extends between the side walls 123 to form a closed end. The upper end of the second elongate hollow body 120 is open and comprises two diametrically opposed L-shaped slots 124 for receiving the pins 115 located at the lower end of the first elongate hollow body 110.

A ceramic based adhesive (Silusil HT1500) is provided at the interface between the first elongate hollow body 110 and the second elongate hollow body 120 to secure the first elongate hollow body 110 and the second elongate hollow body 120 together and to form a gas-tight seal between the first and second elongate hollow bodies 110, 120. In this embodiment a high temperature ceramic cement has been used as the adhesive.

The first and second elongate hollow bodies 110, 120 are joined together by applying the ceramic cement adhesive 131 along the lower wall 112 of the first elongate body 110 and/or along the upper wall 121 of the second elongate hollow body 120. The slots 124 of the second elongate hollow body 120 are then guided over the pins 115 of the first elongate hollow body 110 to bring the first and second elongate hollow bodies 110, 120 into engagement. The second elongate hollow body is then rotated with respect to the first elongate body which locks the pins 115 in the slots 124 and secures the first and second elongate hollow bodies 110, 120 together.

The above embodiment is/embodiments are described by way of example only. Many variations are possible without departing from the scope of the invention.

1. A modular ceramic filter element comprising two or more elongate hollow bodies, wherein the elongate hollow bodies are formed to define twist-lock connection means for joining adjacent elongate hollow bodies together.

2. A filter element according to claim 1, wherein an adhesive is provided at an interface between the elongate hollow bodies.

3. A filter element according to claim 1, wherein the twist-lock connection means comprises a male portion and a female portion for receiving the male portion.

4. A filter element according to claim 3, wherein one end of an elongate hollow body comprises the male portion and another end of an adjacent elongate hollow body comprises the female portion.

5. A filter element according to claim 3, wherein the male portion comprises one or more radial pins.

6. A filter element according to claim 5, wherein the radial pins are diametrically opposed.

7. A filter element according to claim 3, wherein the female portion comprises one or more slots.

8. A filter element according to claim 7, wherein the slot or slots are L-shaped or J-shaped.

9. (canceled)

10. A filter element according to claim 7, wherein the slots are diametrically opposed.

11. A filter element according to claim 1, wherein the twist-lock connection is a bayonet connection.

12. A filter element according to claim 1, wherein an end of one elongate hollow body is tapered and an adjacent end of another elongate hollow body is configured to receive the tapered end.

13. A filter element according to claim 12, wherein the end configured to receive the tapered end has an internal tapered wall.

14. A filter element according to claim 12, wherein the cross-section of the end configured to receive the tapered end is smaller than the tapered end.

15. A filter element according to claim 1, wherein the filter element comprises non-threaded elongate hollow bodies.

16-18. (canceled)

19. A filter element according to claim 1, wherein the filter element is greater than 3 meters in length.

20. (canceled)

21. A filter element according to claim 1, wherein the elongate hollow bodies are substantially tubular.

22. A filter element according to claim 1, wherein the filter element is a filter candle.

23. A method of producing a modular filter element comprising two or more elongate hollow bodies, the method comprising the steps of:
providing a first elongate hollow body having a male portion formed at one end;
providing a second elongate hollow body having a female portion formed at one end;
guiding the female portion over the male portion, and
rotating one or both of the elongate hollow bodies to lock to male portion in the female portion.

24. A filtration apparatus comprising the filter element according to claim 1.

25. Use of the filter element according to claim 1 for filtering particulate matter from hot gas streams.
